(19) United States
(12) Patent Application Publication
(10) Pub. No.: US 2025/0276695 A1
(43) Pub. Date: Sep. 4, 2025

(54) METHOD FOR OPERATING A MOTOR VEHICLE, COMPUTER PROGRAM PRODUCT, STORAGE MEDIUM, COMPUTER DEVICE

(71) Applicant: Robert Bosch GmbH, Stuttgart (DE)

(72) Inventor: Paul Oborowski, Abstatt (DE)

(21) Appl. No.: 19/065,465

(22) Filed: Feb. 27, 2025

(30) Foreign Application Priority Data
Feb. 29, 2024 (DE) 10 2024 201 862.7

(51) Int. Cl. B60W 30/18; B60W 10/08; B60W 10/18

(52) U.S. Cl. CPC B60W 30/18172; B60W 10/08; B60W 10/18; B60W 2510/083; B60W 2520/26; B60W 2520/28; B60W 2540/10; B60W 2540/12; B60W 2710/18; B60W 2720/106

(57) ABSTRACT

A method for operating a motor vehicle. The motor vehicle has at least one axle with at least one wheel. A wheel brake device with a controllable first actuator is assigned to the wheel. A drive device with a controllable second actuator is assigned to the wheel. Depending on an acceleration request or braking request, at least one target torque value and at least one further target value, selected from a slip target value and a rotational speed target value, are specified. For the target torque value, a distribution factor for distributing the target torque value to the actuators is specified. At least one, in particular exactly one, of the actuators is controlled to fulfill the acceleration request or braking request depending on the specified target values and the distribution factor.

### FIELD

The present invention relates to a method for operating a motor vehicle, wherein the motor vehicle has at least one axle with at least one wheel, wherein a wheel brake device with a controllable first actuator, in particular an electric machine, is assigned to the wheel, and wherein a drive device with a controllable second actuator, in particular an electric machine, is assigned to the wheel.

Furthermore, the present invention relates to a computer program product which performs the above method if the computer program product is executed on a computer device. Furthermore, the present invention relates to a machine-readable storage medium with such a computer program product and to a computer device which is specifically configured to execute the computer program product or to carry out the above-mentioned method.

### BACKGROUND INFORMATION

It is conventional to carry out slip regulation in motor vehicles. The aim of slip regulation is to regulate a given target slip at a wheel, in particular by specifying a slip target value, or rotational speed target value, dependent on the target slip. In motor vehicles, a friction brake is usually used for this purpose. The brake torque acting on the wheel can be influenced by controlling the caliper force in order to regulate the desired wheel slip, for example as part of an anti-lock braking system (ABS) or slip regulation system (ASR, TCS). The slip regulation can therefore be used during both acceleration and braking.

### SUMMARY

According to an example embodiment of the present invention, depending on an acceleration request or braking request, at least one torque target value and at least one further target value selected from a slip target value and a rotational speed target value are specified. A distribution factor for the torque target value is specified for distributing the torque target value among the actuators. At least one, in particular exactly one, of the actuators is controlled to fulfill the acceleration request or braking request depending on the specified target values and the distribution factor. This ensures a particularly advantageous slip regulation in which each of the actuators involved can use its maximum possible dynamic potential. As mentioned above, it is common practice to carry out slip regulation at least via a wheel braking device. In electric vehicles, it is expedient to include the electric drive motor for wheel slip regulation, as it provides torque very quickly and very precisely. One challenge here is to take the operating limits of the drive machine into account in the wheel slip regulation. This often does not provide enough torque to set the desired slip on its own, i.e., without the support of other actuators, such as the friction brake. At the same time, however, it is desirable to exploit the potential of the electric machine to the greatest possible extent. This maximizes the recuperated energy when braking, and maximizes the vehicle acceleration when driving. In both cases, it is advantageous to avoid the use of the friction brake and thus to avoid wear and brake dust as much as possible. Control methods are possible in which the approach of prioritizing the actuators for slip regulation is pursued. A distinction is made between a main actuator and an auxiliary actuator. The main actuator provides a very dynamic torque contribution to hold the wheel slip at a given operating point. Each additional auxiliary actuator only provides a slow torque contribution and thus only acts for long-term corrections, for example to prevent the main actuator from running against an operating limit. In regulating methods for electric vehicles, it is therefore possible that the electric machine takes on the role of the main actuator. It can vary the torque very dynamically and precisely, as long as the required torque is within the possible operating range of the drive. The latter point is ensured by the friction brake, which provides the smallest and slowest possible contribution in order to ensure that the electric machine is operated at an optimal operating point. With this distribution, in the event of sudden changes, for example due to jumps in the friction coefficient, the friction brake must briefly regulate the wheel when the electric machine approaches its operating limit in order to bring the wheel to the target slip. For this purpose, it is necessary to monitor the torque of the electric machine relative to its operating limit in order to trigger a switchover in a timely manner. It is inherent to this approach that, in particular, waiting times must be observed in order to give the regulation system, via the electrical machine, the opportunity to independently correct minor disturbances. The handling when switching the actuator strategy is therefore difficult and carries the risk that the slip operating point is lost for a period of time in order to readjust the distribution of the torque contributions of the actuators. However, it is desirable not to lose precisely this slip operating point in order to ensure that the higher level functionality, such as the anti-lock braking system and/or slip regulation, always functions optimally. The method according to the present invention completely avoids these disadvantageous behaviors. For this purpose, according to the present invention the further target value, i.e. either the slip target value or the rotational speed target value, is specified. This provides a final target slip to be regulated for each wheel. The present invention describes a regulation method for slip regulation at a wheel, which controls a plurality of redundant actuators that are mechanically coupled to the wheel in order to carry out the task of slip regulation. A special feature here is that each actuator can use its maximum dynamic potential and there is no prioritization. This makes it possible to regulate the slip at the wheel with even greater accuracy than with the approaches described above and, in particular, to avoid deviations from the target slip even when an actuator is approaching its operating limit, i.e. generating a maximum torque. The corresponding wheel slip regulation advantageously further improves vehicle functionalities, such as anti-lock braking systems and slip regulation, while at the same time reducing the energy requirement for the actuators from an energy storage device, in particular an HV battery, and avoiding brake wear. The regulation method according to the present invention consists of two parts, namely on the one hand the target value specification, by means of which a target value torque operating point and a target slip (or a target rotational speed) are specified for at least one, in particular each, of the actuators, and which is for example a higher level system, in particular in a central control apparatus. The basis for this is preferably an input interface to a higher level vehicle function that requests wheel slip regulation and provides a wheel-specific target slip (or a target rotational speed). On the other hand, the method includes a hybrid regulation of the target slip and the target torque operating point, individually for each actuator, by controlling the actuators accordingly depending on the target values. Preferably, the slip regulation of the actuator in each case comprises ascertaining an actual slip value and taking this into account in addition to the specified individual target slip in the independent wheel regulation. In summary, the advantages of the method according to the present invention include avoiding the loss of the slip operating point by switching actuators, for example when the operating limit of an individual actuator is reached, more precise slip regulation by using the full dynamics of each actuator, better utilization of the torque potential of the electric machines, continuous redundancy because no explicit switchover is necessary if an actuator fails, but the actuator that is still functional reacts immediately to a slip deviation caused by the failure, the possibility of distributing the functional components between control units because a clear distinction can be made between slow and fast functional components, the scalability of the regulation method with regard to the type of actuators and the topology of the actuators in the vehicle, and finally the possibility of bringing one of the actuators close to its operating maximum, so that, so to speak, a behavior can be achieved in which an actuator has only little dynamic torque contribution, for example to leverage advantages in the area of NVH (noise, vibration, harshness).

According to a preferred development of the present invention, it is provided that the axle has a second wheel and that a wheel braking device is assigned to each wheel. In this respect, at least one actuator, namely the wheel brake device, is also assigned to the second wheel, which device can be or is controlled depending on the specified target values and the distribution factor. Thus, overall, advantageous regulation for a plurality of wheels is ensured by means of the method according to the present invention in order to improve the slip regulation for the motor vehicle as a whole on at least one axle as described above.

According to an example embodiment of the present invention, it is particularly preferably provided that the drive device is assigned to the wheels together or that a drive device is assigned to each wheel, wherein at least one of the further target values in each case is specified for the respective first and second actuator. This results in the advantage that an overall system consisting of at least three actuators, namely two first actuators each assigned to a different wheel braking device and at least one second actuator assigned to a drive device, is advantageously optimized in the slip regulation. The drive device preferably acts on the two wheels via an open differential.

According to a preferred development of the present invention, it is provided that when a braking request is detected, the one, or each, second actuator is/are controlled depending on the torque target value and the further target value, and/or each first actuator is/are controlled only depending on the further target value. This creates a particularly advantageous regulation strategy for a braking request, in which all actuators involved are controlled by means of a slip regulation and only the actuator(s) of the drive device are additionally controlled by means of a torque regulation.

According to an example embodiment of the present invention, it is particularly preferably provided that when an acceleration request is detected, each first actuator is/are controlled depending on the corresponding torque target value and the corresponding further target value, and/or the one, or each, second actuator is/are controlled only depending on the corresponding further target value. This creates a particularly advantageous regulation strategy for an acceleration request, in which all actuators involved are controlled by means of a slip regulation and only the actuator(s) of the wheel brake devices are additionally controlled by means of a torque regulation.

According to a preferred development of the present invention, it is provided that actual torque values of the actuators are ascertained and that the torque target value in each case is specified depending on the actual torque values. This advantageously ensures that each torque target value is specified in a particularly robust manner.

According to an example embodiment of the present invention, it is particularly preferred that the distribution factor is specified depending on a maximum torque that can be generated by the corresponding actuator. This has the advantage that the torque potential of the corresponding actuators is always optimally utilized.

According to a preferred development of the present invention, it is provided that the target values are specified by a central control apparatus and/or that each of the actuators is assigned its own control device, in particular one that is communicatively connected to the central control apparatus, wherein each of the actuators is controlled by the control device assigned to it. The advantage of the specification by a central control apparatus is that the target values, as described above, are specified in advance and are valid for all actuators. If an independent control device is used for each of the actuators, the advantage is that the actuators can always be controlled safely and independently of one another. The combination of a central control apparatus and independent control devices is particularly advantageous, so that the central control apparatus specifies the target values and passes them on to the control devices via a communication connection, so that the regulation task lies with the control devices.

A computer program product according to the present invention for execution on a computer device carries out the method according to the present invention when used as intended. This results in the advantages mentioned above.

A machine-readable storage medium according to the present invention includes the computer program product according to the present invention stored thereon.

A computer device according to an example embodiment of the present invention is specifically configured to execute the computer program product according to the present invention or to carry out the method according to the present invention. This also results in the advantages mentioned above. Preferably, the computer device is a control apparatus and/or control device assigned to a motor vehicle, in particular arranged in the motor vehicle.

For example, a corresponding motor vehicle has at least one axle with at least one wheel, wherein a wheel brake device with a controllable first actuator, in particular an electric machine, is assigned to the wheel, and wherein a drive device with a second controllable actuator, in particular an electric machine, is assigned to the wheel, and is characterized by at least one computer device according to the present invention designed as a central control apparatus and/or a computer device according to the present invention designed as a control device assigned to at least one of the actuators. This results in the advantages mentioned above. Particularly preferably, the motor vehicle has at least a first and a second wheel on the axle, wherein the first wheel, in particular assigned to a left side of the motor vehicle, is assigned a first wheel braking device with a controllable first actuator, in particular an electric machine, wherein the second wheel, in particular assigned to a right side of the motor vehicle, is assigned a second wheel braking device with a further controllable first actuator, in particular an electric machine, and wherein the wheels are assigned a common drive device, or each of the wheels is assigned a separate drive device, with one, or each with a, controllable second actuator, in particular an electric machine. This also results in the advantages mentioned above.

Further preferred features and combinations of features result from what is disclosed herein. The present invention is explained in more detail below with reference to the figures.

### BRIEF DESCRIPTION OF THE DRAWINGS

FIG. 1 shows an advantageous method for slip regulation at the wheel level, according to an example embodiment of the present invention.

FIG. 2 shows a first application of the method at the axle level, derived from FIG. 1, according to an example embodiment of the present invention.

FIG. 3 shows a second application of the method at the axle level, derived from FIG. 1, according to an example embodiment of the present invention.

### DETAILED DESCRIPTION OF EXAMPLE EMBODIMENTS

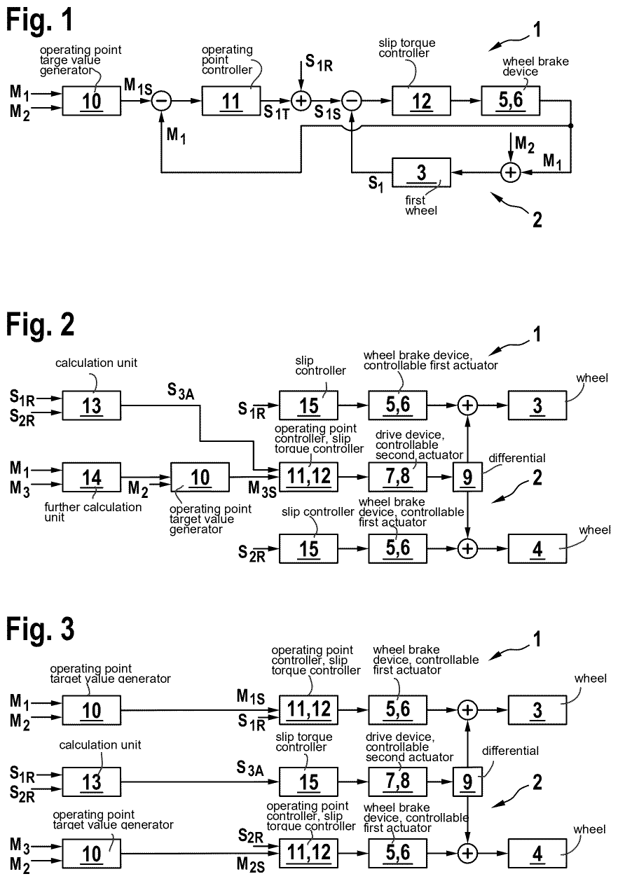

FIG. 1 shows steps of an advantageous method for slip regulation of a motor vehicle 1 at the wheel level, wherein the motor vehicle 1 has at least one axle 2 with at least one wheel 3. The method is therefore shown for a single, first wheel 3, wherein the motor vehicle 1 preferably has at least one further, second wheel 4 on the axle 2, for which the same regulation structure is provided.

This is illustrated in FIGS. 2 and 3, which each show further developments of the method derived from FIG. 1 with respect to the axle plane, i.e. for both wheels 3, 4, which are correspondingly each assigned to different sides of the motor vehicle, in particular the first wheel 3 to a left side and the second wheel 4 to a right side. For example, the axle 2 is a front axle or a rear axle. It is also possible to provide the structure shown for both a front axle and a rear axle, for example in all-wheel drive vehicles.

In any case, the wheel 3 in FIG. 1 is assigned a wheel brake device 5 with a controllable first actuator 6, which in the present case is designed as an electric machine. As can be seen in FIGS. 2 and 3, the wheel 4 is also assigned its own wheel braking device 5 with its own first actuator 6. Both wheels 3, 4 are also assigned a drive device 7 with a controllable second actuator 8, which in this case is designed as an electric machine, by means of a differential 9 arranged on the axle 2.

The actual method for slip regulation (instead of the slip, a rotational speed can also be specified or regulated directly) works for the individual wheel 3 using the example in FIG. 1 as follows: first, depending on an acceleration request or braking request, a first torque target value M_{1S} is specified by means of an operating point target value generator 10. The operating point target value generator 10 is in particular part of a central control apparatus.

To determine the torque value M_{1S}, the actual torque values of the actuators 6, 8 acting on the wheel 3 are ascertained as input variables to the operating point target value generator 10, i.e. a first actual torque value M₁ of the first actuator 6 of the wheel brake device 5 assigned to the wheel 3 and a second actual torque value M₂ of the second actuator 8 of the drive device 7. In addition, a distribution factor for distributing the target torque value M_{1S} to the actuators 6, 8 is specified for the target torque value M_{1S}.

This distribution factor makes it possible to set a certain ratio of the torque contributions of the individual actuators to each other. In particular, it is provided that only one of the actuators provides torque, or that both actuators provide torque according to a given ratio, for example 1 to 1, 2 to 1, 3 to 1, etc.

In particular, it is intended that one of the actuators provides a maximum torque contribution, but only up to a certain limit of the other actuator. In addition, the central operating point target value determination also makes it possible to only carry out a degree of trimming of the affected controller until the total torque of all actuators has been reached and thus further trimming would no longer be effective because no more torque can be delivered via the affected actuator.

A difference is now formed from the first target torque value M_{1S} and the first actual torque value M₁ and is transferred to an operating point controller 11 and a further target value, selected from a slip target value and a rotational speed target value, is specified. In this case, a first slip target value SIR is specified for the first wheel 3, and as the sum of a trim slip value S_{1T} specified by the operating point controller 11 and the target slip value S_{1R} a slip target value S_{1S} is ascertained for the actuator 6, wherein the trim slip value S_{1T} determines a slip change at the wheel 3 in order to reach the corresponding operating point.

The purpose of this operating point regulation is to regulate the torque contribution of the actuator 6, 8 to a target value by determining the trim slip by which the actuator 6, 8 regulates more or less slip in order to reach the desired operating point. The described method can also be applied if a wheel rotational speed is defined as a controlled variable instead of a slip and a corresponding target rotational speed is provided for each wheel by a higher level vehicle function.

Subsequently, a difference between the slip target value Sis and a first actual slip value Si of the wheel 3 which is also ascertained is formed and passed to a slip torque controller 12. The slip torque controller 12 now controls the first actuator 6 to fulfill the acceleration request or braking request depending on the specified target values and the distribution factor. The slip torque controller 12 and/or the operating point controller 11 is/are, for example, part of a control device assigned to the actuator 6.

All other actuators 6, 8 use the same structure and ultimately make their own contribution to wheel slip regulation via their mechanical coupling to the respective wheel 3, 4, which is additively superimposed. The actual torque acting on wheel 3 is the sum of the first actual torque value M₁ and the second actual torque value M₂.

The operating point regulation is connected upstream of the slip regulation and is preferably set slower than the slip regulation. This ensures that the actuator implements the target slip of the higher level vehicle function with high priority and adjusts the operating point with lower priority, which is advantageous in terms of implementing the higher level vehicle function.

The described regulation structure can now be used, as shown in FIGS. 2 and 3, to integrate the described actuators into the regulation as the two first actuators 6 and the one second actuator 8. The operating point regulation is only applied to n−1 actuators because the physical degree of freedom of the system cannot be further exploited and would otherwise be overdetermined.

To regulate the slip in an electric vehicle, it is advantageous to carry out the operating point regulation via the drive device in the event of braking. FIG. 2 shows how the regulation works in a corresponding first application of the method when a braking request is detected.

Then only the second actuator 8 [sic]¹ depending on a corresponding third torque target value M_{3S} and the corresponding further target value, in this case, analogous to FIG. 1, a third slip target value S_{3A} for the axle 2. In the present case, this target value is ascertained in a calculation unit 13 as the mean value of the first slip setpoint value S_{1R} for the first wheel 3 and a corresponding second slip target value Ser for the second wheel 4, as considered in FIG. 1. ¹[Translator's note: Word or word(s) missing.]

The third target torque value Mas is specified, analogously to FIG. 1, using a corresponding operating point target value generator 10. The actual torque value M₂ of the second actuator 8, already considered in FIG. 1, and a minimum of the first actual torque value M₁ of the actuator 6 assigned to the first wheel 3 and a third actual torque value M₃ of the actuator 6 assigned to the second wheel 4, determined by a further calculation unit 14, are used as input variables.

The third torque target value M_{3S} and the third slip target value S_{3A} are correspondingly used as input variables for an operating point controller 11 and slip torque controller 12 designed analogously to FIG. 1.

The first actuators 6 in each case are accordingly controlled depending only on the further target value, namely the actuator 6 assigned to the first wheel 3 depending on the first slip target value S_{1R} for the first wheel 3 by means of a simple slip controller 15, and the actuator 6 assigned to the second wheel 4 depending on the second slip target value S_{2R} for the second wheel 4 by means of a slip controller 15.

For example, as torque target value M_{3S}, a freely definable fraction of a maximum possible braking torque of the actuator 8 is used as a specification, which is typically provided by an inverter or by a higher level vehicle controller. If the full torque potential is specified as the target value, the drive device will make a maximum contribution to wheel slip regulation on average over time. However, if only a fraction is specified, for example 50% of the maximum possible torque, it is ensured that the wheel slip regulation, via the drive device, still has reserves for compensating for disturbing variables and can dynamically increase or decrease its torque contribution without reaching its operating limit.

When used as a brake slip regulation in an electric vehicle, it is particularly advantageous to set the method in such a way that the torque potential of the electric drive device is exploited until an adjustable minimum contribution from the wheel brake devices is reached, so that they themselves do not run up against their operating limit, and continue to make a dynamic contribution to the slip regulation.

A possible form of the function of the operating point target value generator would then be, for this application (delaying torques have a positive sign):
1. Specifying a maximum value for a torque operating point of the actuator 6 (friction brake),
2. specifying a maximum value for a torque operating point of the actuator 8 (drive),
3. ascertaining the sum of all the actual torques acting on each wheel 3, 4, which originate from the actuators 6, 8, using the actual torque values M₁, M₂ or M₂, M₃ (corresponding to the tire potential),
4. ascertaining the maximum of zero and the difference between the sum ascertained in (3) and the maximum value specified in (1) (target value for the drive from the tire potential and the friction brake target value), and
5. calculating the minimum of the maximum ascertained in (4) and the maximum value specified in (2)—this value corresponds to the torque target value M_{3S}, i.e. a final target operating point of the actuator 8.

For use in an electric vehicle in which the drive is coupled via an open differential, it is advantageous to take into account the wheel 3, 4 with the smaller coefficient of friction when determining the operating point of the actuator 8. This is always the wheel at which the slip controllers can apply the lower torque via the friction brake. It should be noted that the slip regulation of the drive can be carried out by detecting the rotational speed of the corresponding actuator or by supplying an external signal which represents the average rotational speed of the wheels 3, 4 or the average slip of the wheels 3, 4.

For regulation in the drive case, however, it is advantageous to carry out the operating point regulation via the wheel brake devices (friction brakes) and, for example, to specify 0 Nm as the target torque value. This prevents unnecessary braking of the drive device and still allows the system to react to disturbances that require the friction brakes to intervene, such as a negative jump in the friction coefficient.

For an application, such as slip regulation, an analogous sequence of operations for the function of the operating point target value generator is therefore recommended (accelerating moments have a positive sign, the actuators 6 correspondingly have values between minus infinity and 0).

In the case of slip regulation for an electric vehicle with axle drive and two friction brakes, it is advantageous to determine the operating point for each friction brake separately by taking the torque of the actuator 8 into account for each wheel 3, 4 when calculating the target value (an open differential distributes half of the engine torque to each of the two wheels).

FIG. 3 shows how the regulation works in a corresponding second application case of the method when an acceleration request is detected. In contrast to FIG. 2, only the first two actuators 6 are controlled depending on their target torque value and the further target value in each case, and the second actuator 8 is only controlled depending on the further target value.

The second actuator 8 is therefore only controlled in dependence on the corresponding third slip target value S_{3A} for the axle 2 by means of a slip controller 15. This target value is calculated, as in FIG. 2, in the computing unit 13 as a mean value of the first slip target value S_{1R} for the first wheel 3 and the second slip target value Ser for the second wheel 4.

The first actuator 6 assigned to the first wheel 3 is controlled accordingly depending on the first target torque value M_{1S} and the first slip target value S_{1R} for the first wheel 3. The first torque target value M_{1S} is specified by means of the corresponding operating point target value generator 10. The first actual torque value M₁ of the actuator 6 assigned to the first wheel 3 and the second actual torque value M₂ of the second actuator 8 are used as input variables. The first torque target value M_{1S} and the first slip target value S_{1R} are correspondingly used as input variables for the operating point controller 11 and slip torque controller 12.

The first actuator 6 assigned to the second wheel 4 is controlled accordingly depending on the second target torque value M_{2S} and the second slip target value S_{2R} for the second wheel 4. The second target torque value M_{1S} is specified by means of the corresponding operating point target value generator 10. The third actual torque value M₃ of the actuator 6 assigned to the second wheel 4 and the second actual torque value M₂ of the second actuator 8 are used as input variables. The second target torque value M_{2S} and the second slip target value S_{2R} are correspondingly used as input variables for the operating point controller 11 and slip torque controller 12.

1-11. (canceled)

12. A method for operating a motor vehicle, wherein the motor vehicle has at least one axle with at least one wheel, the wheel is assigned a wheel brake device with a controllable first actuator which includes an electric machine, and the wheel is assigned a drive device with a controllable second actuator which includes an electric machine, the method comprising the following steps:
depending on an acceleration request or a braking request, specifying at least one target torque value and at least one further target value, selected from a slip target value and a rotational speed target value;
specifying, for the target torque value, a distribution factor for distributing the target torque value to the first and second actuators; and
controlling one of the first and second actuators to fulfill the acceleration request or braking request depending on the specified target torque value, specified further target value, and the distribution factor.

13. The method according to claim 12, wherein the axle has a second wheel, and each of the first and second wheels have assigned to it a corresponding wheel braking device.

14. The method according to claim 13, wherein: (i) the drive device is assigned to the first and second wheels together or (ii) a corresponding drive device is assigned to each of the first and second wheels, wherein at least one corresponding one of the further target values is specified to the first and second actuator in each case.

15. The method according to claim 14, wherein when the braking request is detected, the second actuator is controlled depending on the torque target value and the corresponding further target value, and/or the first actuator is controlled only in dependence on the corresponding further target value.

16. The method according to claim 15, wherein when the acceleration request is detected, the first actuator is controlled depending on the corresponding torque target value and the corresponding further target value, and/or the second actuator is controlled only in dependence on the corresponding further target value.

17. The method according to claim 12, wherein actual torque values of the actuators are ascertained, and the torque target value is specified in each case depending on the actual torque values.

18. The method according to claim 12, wherein the distribution factor is specified dependent on a maximum torque that can be generated by first and/or second actuator.

19. The method according to claim 12, wherein the target values are specified by a central control apparatus, and/or each of the first and second actuators is assigned its own control device, communicatively connected to the central control apparatus, wherein each of the first and second actuators is controlled by the control device assigned to it.

20. A non-transitory machine-readable storage medium on which is stored a computer program for operating a motor vehicle, wherein the motor vehicle has at least one axle with at least one wheel, the wheel is assigned a wheel brake device with a controllable first actuator which includes an electric machine, and the wheel is assigned a drive device with a controllable second actuator which includes an electric machine, the computer program, when executed by a computer device, causing the computer device to perform the following steps:
depending on an acceleration request or a braking request, specifying at least one target torque value and at least one further target value, selected from a slip target value and a rotational speed target value;
specifying, for the target torque value, a distribution factor for distributing the target torque value to the first and second actuators; and
controlling one of the first and second actuators to fulfill the acceleration request or braking request depending on the specified target torque value, specified further target value, and the distribution factor.

21. A computer device, comprising an electronic control apparatus and/or control device, for a motor vehicle, the computer device configured to operate the motor vehicle, wherein the motor vehicle has at least one axle with at least one wheel, the wheel is assigned a wheel brake device with a controllable first actuator which includes an electric machine, and the wheel is assigned a drive device with a controllable second actuator which includes an electric machine, the computer device configured to:
depending on an acceleration request or a braking request, specify at least one target torque value and at least one further target value, selected from a slip target value and a rotational speed target value;
specify, for the target torque value, a distribution factor for distributing the target torque value to the first and second actuators; and
control one of the first and second actuators to fulfill the acceleration request or braking request depending on the specified target torque value, specified further target value, and the distribution factor.
